(19) United States
(12) Patent Application Publication
(10) Pub. No.: US 2016/0061439 A1
(43) Pub. Date: Mar. 3, 2016

(54) AN AIRSTREAM AND LED LIGHTBEAM LUMINAIRE

(71) Applicants: Josef VALCHAR, Austin, TX (US); Pavel JURIK, Austin, TX (US); ROBE LIGHTING, INC., Sunrise, FL (US)

(72) Inventors: Pavel Jurik, Postredni Becva (CZ); Josef Valchar, Postredni Becva (CZ)

(21) Appl. No.: 14/782,591

(22) PCT Filed: Apr. 4, 2014
(86) PCT No.: PCT/US14/32930

§ 371 Date: Oct. 5, 2015

Related U.S. Application Data
(60) Provisional application No. 61/808,606, filed on Apr. 4, 2013.

(51) Int. Cl. F21V 33/00; A63J 5/02; F21V 14/00

(52) U.S. Cl. CPC F21V 33/0096; F21V 14/00; A63J 5/025; F21Y 2101/02

(57) ABSTRACT

Described is a LED Luminaire combined with a theatrical fan for generating a combined blast of air and beam of light directed in a common direction.

### RELATED APPLICATION

This application is filed claiming priority to U.S. Provisional application Ser. No. 61/808,606 filed on the 4 Apr. 2013.

### TECHNICAL FIELD OF THE INVENTION

The present invention generally relates to a combined fan and LED luminaire, specifically to a method for controlling the coordinated direction of both the air flow and light.

### BACKGROUND OF THE INVENTION

High power LEDs are commonly used in luminaires—for example in the architectural lighting industry in stores, offices and businesses as well as in the entertainment industry in theatres, television studios, concerts, theme parks, night clubs and other venues. These LEDs are also being utilized in automated lighting luminaires with automated and remotely controllable functionality. For color control it is common to use an array of LEDs of different colors. For example a common configuration is to use a mix of Red, Green and Blue LEDs. This configuration allows the user to create the color they desire by additively mixing appropriate levels of the three colors. For example illuminating the Red and Green LEDs while leaving the Blue extinguished will result in an output that appears Yellow. Similarly Red and Blue will result in Magenta, and Blue and Green will result in Cyan. By judicious control of these three controls the user may achieve any color they desire within a color gamut. More than three colors may also be used and it is well known to add an Amber or White LED to the Red, Green and Blue to enhance the color mixing and improve the gamut of colors available.

The differently colored LEDs may be arranged in an array in the luminaire where there is physical separation between each LED, and this separation, coupled with differences in die size and placement for each color, may affect the spread of the individual colors and results in objectionable spill light and/or color fringing of the combined mixed color output beam. It is common to use a zoom lens or other optical device in front of each LED to allow the user to control the beam shape and angle of the output beam; however these optical devices commonly have differing effect for different colors and color fringing or other aberrations may be visible in the output beam. It would be advantageous to have a system where the beam angle is remotely variable and where stray light and aberrations are well controlled.

It is also common to utilize fans on stage, they can be used to help direct theatrical fog or haze into the right areas so as to emphasize light beams, or as an effect on a performer or scenery. For example, a fan may be used at the front of a stage pointing upwards so as to blow into a performer's hair. These fans are usually fixed in position.

It would be advantageous if the fan's positioning could be remotely controlled so as to be able to be directed at a moving performer, and to integrate lighting with the fan so that it simultaneously follows the same performer.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an embodiment of a fan luminaire;

FIG. 2 illustrates an elevation view of an embodiment of the fan luminaire;

FIG. 3 illustrates the air flow through an embodiment of the fan luminaire;

FIG. 4 illustrates an exploded view of an embodiment of the fan luminaire;

FIG. 5 illustrates a single LED module of an embodiment of the fan luminaire;

FIG. 6 illustrates a side view of the LED module array of an embodiment of the invention;

FIG. 7 illustrates a schematic of an embodiment of the fan luminaire operating with a fog machine;

FIG. 8 illustrates a schematic of a further embodiment of the fan luminaire operating with a fog machine;

FIG. 9 illustrates a schematic of a further embodiment of the air channel luminaire with the air channel located outside the LED array; and

FIG. 10 illustrates a schematic of a further embodiment an air channel luminaire with the airchannel interspaced within the LED array.

### DETAILED DESCRIPTION OF THE INVENTION

Preferred embodiments of the present invention are illustrated in the FIGUREs, like numerals being used to refer to like and corresponding parts of the various drawings.

The present invention generally relates to a combined fan and LED luminaire, specifically to a method for controlling the coordinated direction of both the air flow and light.

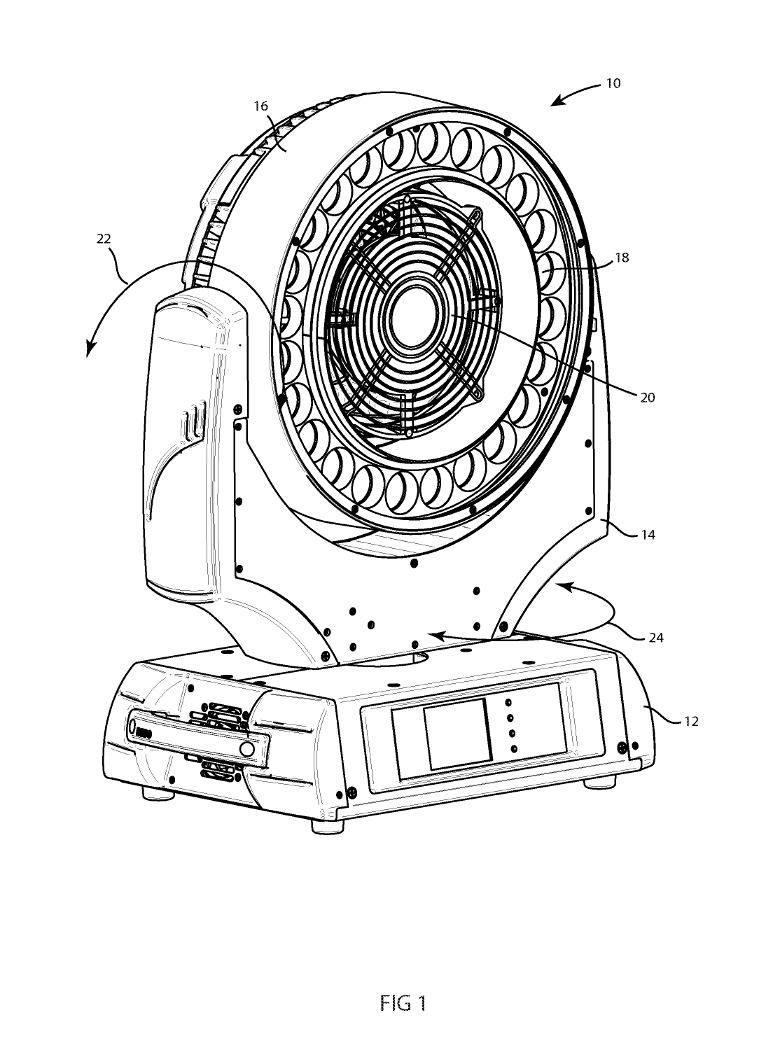

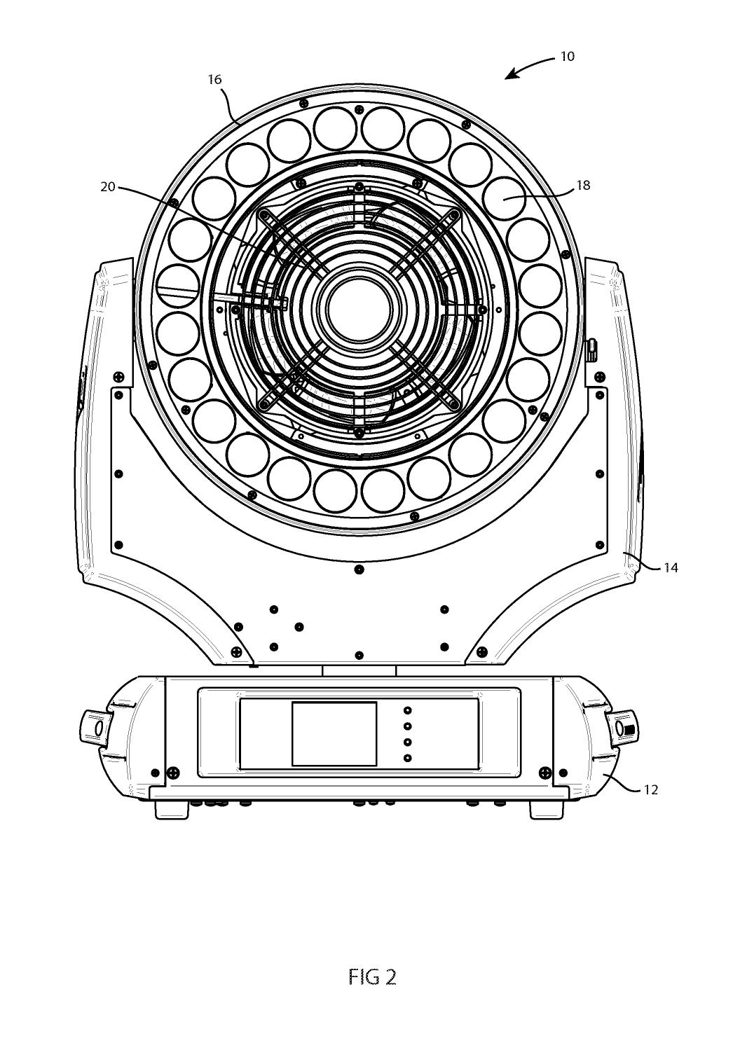

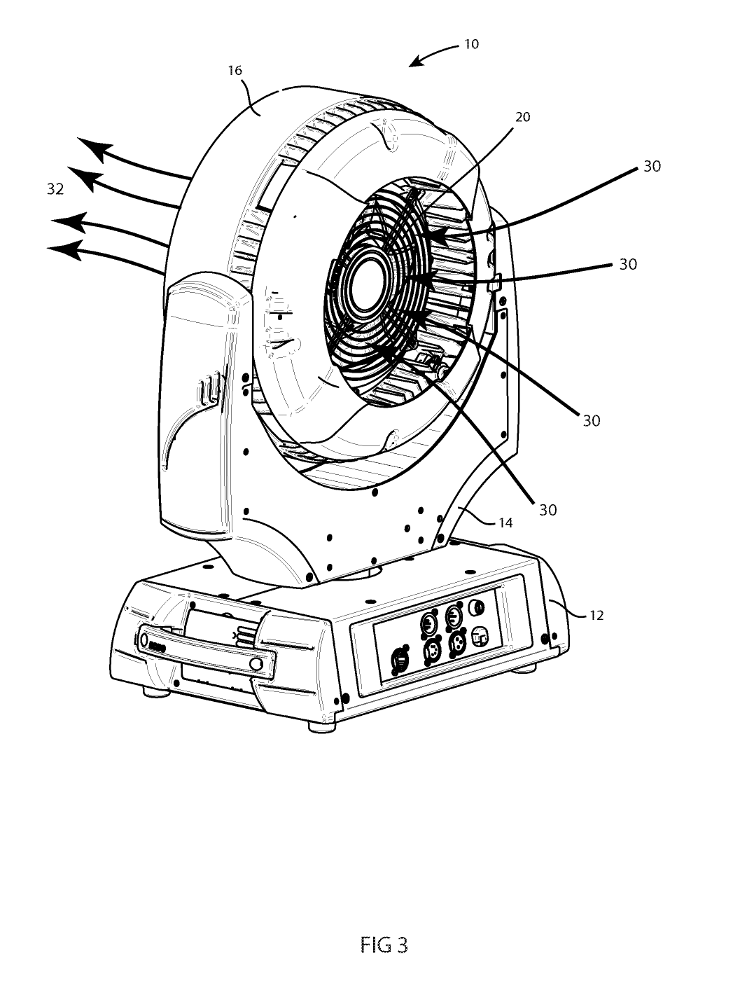

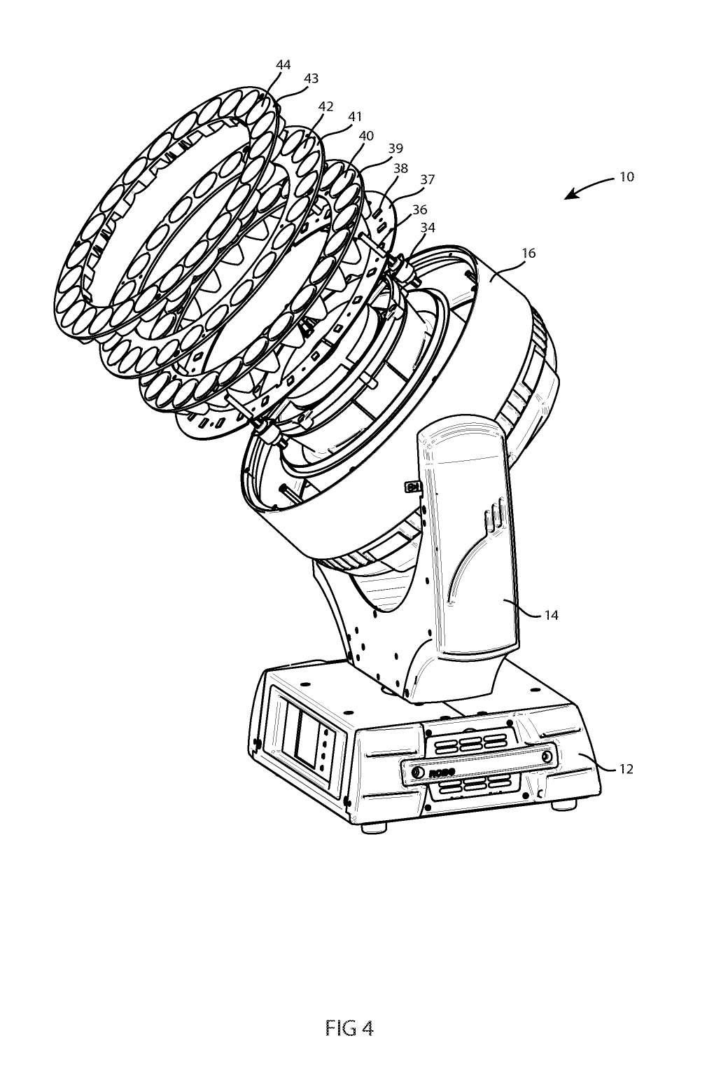

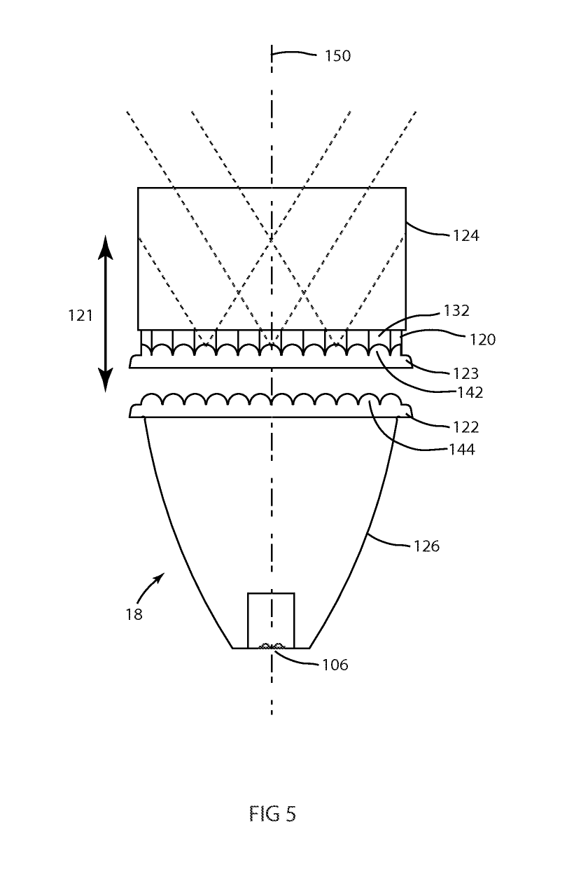

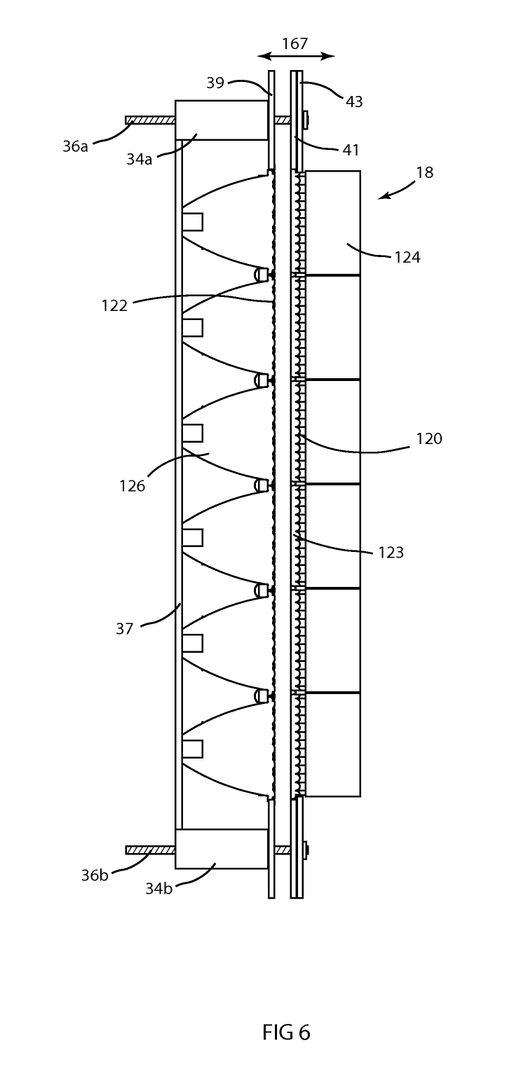

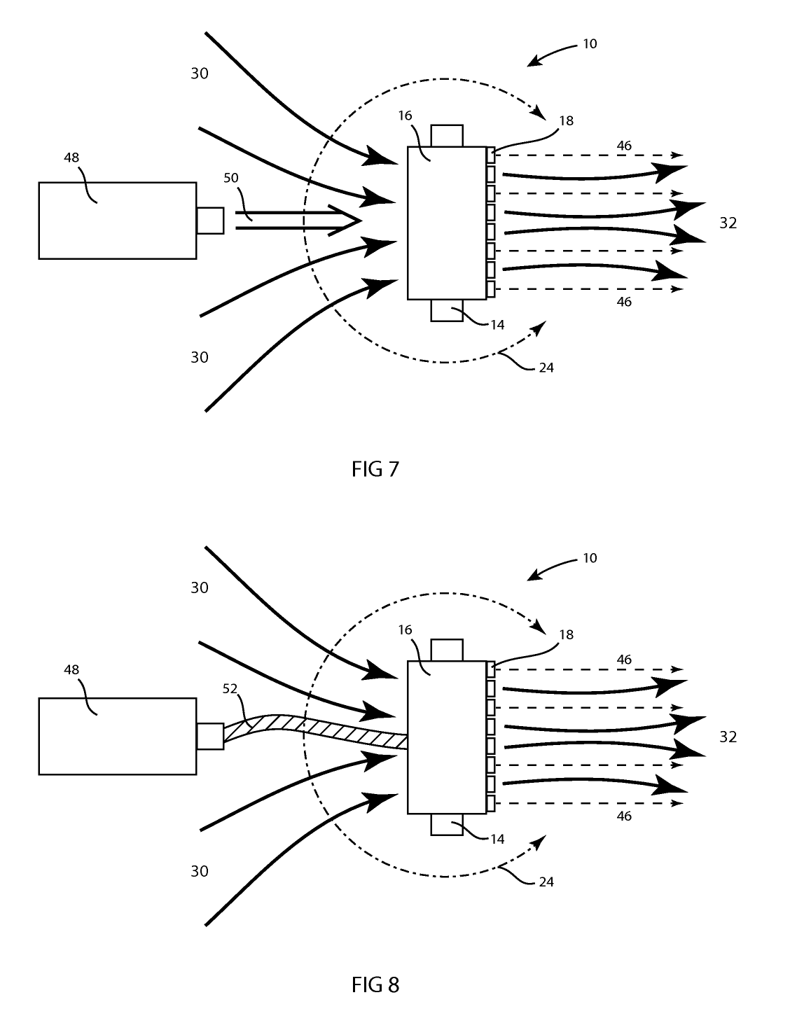

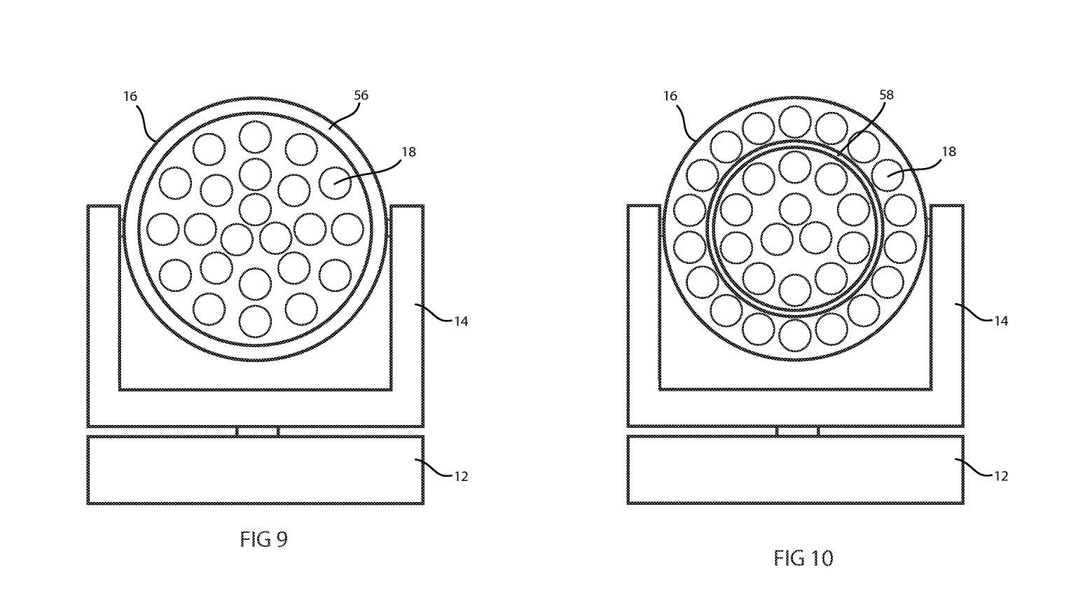

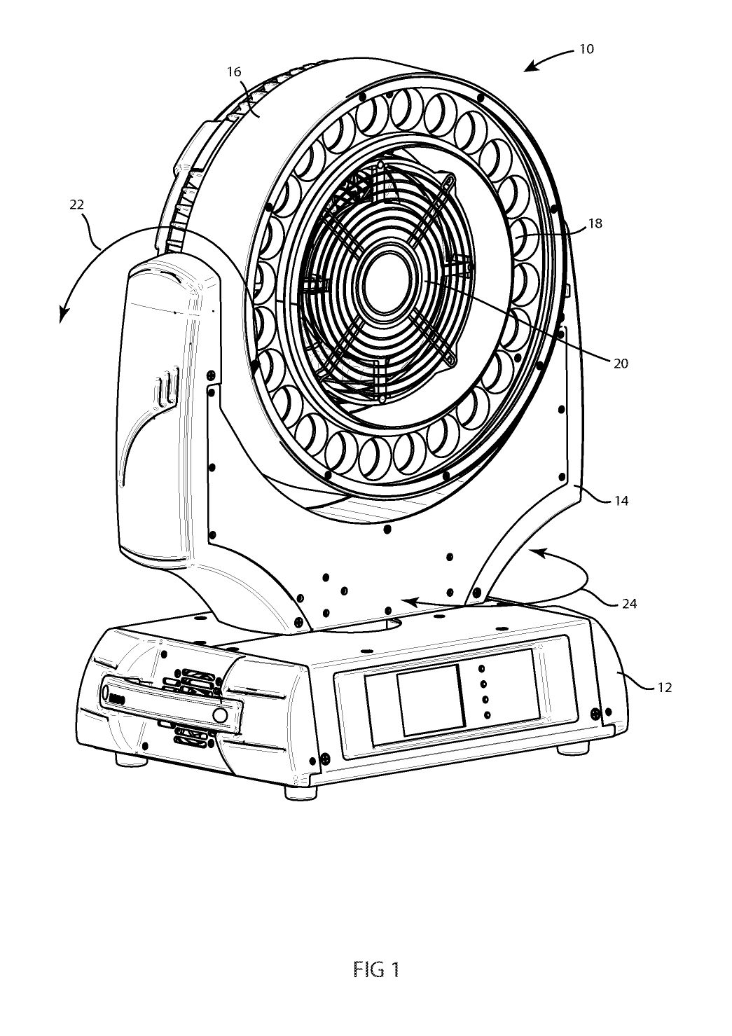

FIG. 1 illustrates an embodiment of the luminaire fan 10. Fixture head 16 is rotatably mounted in a yoke 14 which, in turn is rotatably mounted to base 12. This provides two orthogonal axes of rotation for head 16, tilt 22 within yoke 14 and pan 24 from yoke 14 to base 12. Each axis may have a full 360° of rotation or be limited by rotational stops as desired. Base 12 may be sited on the floor or on a stage or may be inverted and hung from trussing or other suspension equipment as is well known in the art.

Head 16 contains an array of LED modules 18. Here shown as a circular array, however the invention is not so limited and the array of LED modules may be of any shape. The array of LED modules 18 surrounds a fan 20. Fan 20 is controllable by the user as to its speed and directs a jet of air from the center of the fixture 10.

LED modules 18 may each contain a plurality of LED emitters. In various embodiments Each LED module 18 may comprise a single LED die of a single color or a group of LED dies of the same or differing colors. For example in one embodiment LED modules 18 each contain one each of a Red, Green, Blue and White die. In some embodiments these LED die(s) may be paired with optical lens element(s) as part of LED module 18.

Fan 20 may be used on its own as a directable fan using the pan and tilt rotation provided by the fixture. Thus it may be remotely controlled to direct the fan's position and power. It may also be used in conjunction with LED modules 18 so as to direct both air and light simultaneously and in a coordinated manner.

FIG. 2 illustrates an elevation view of an embodiment of the invention showing more clearly the ring of LED modules 18 surrounding fan 20. Both LED modules 18 and fan 20 will move together and produce parallel beams of light and air.

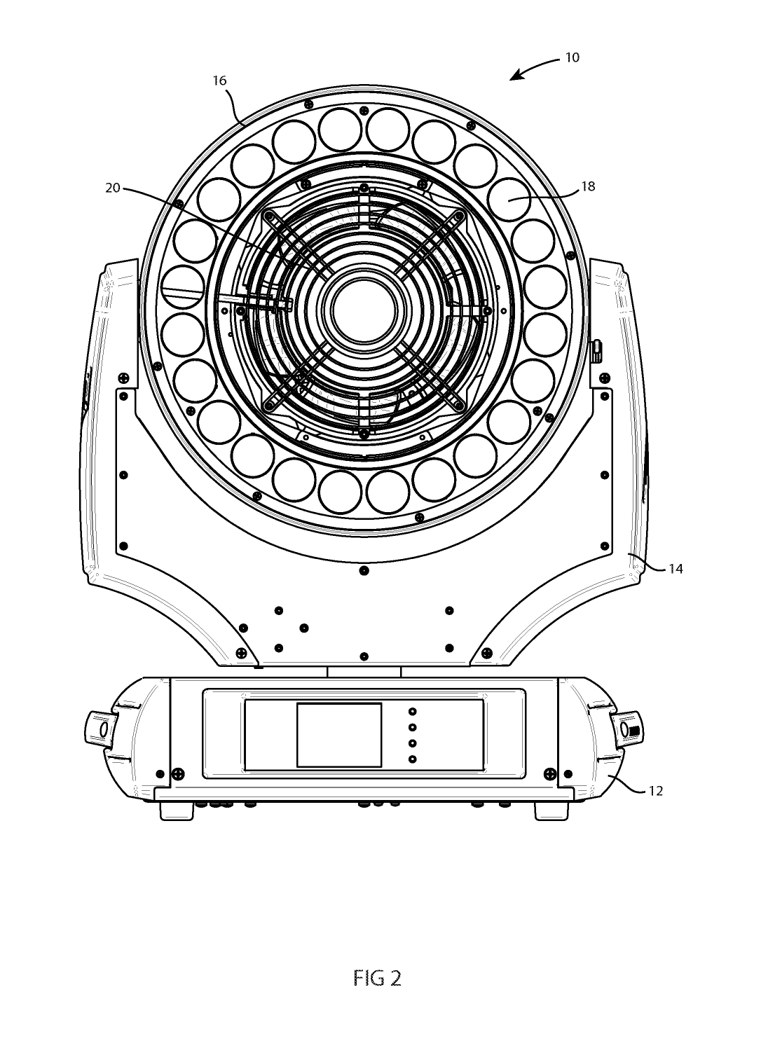

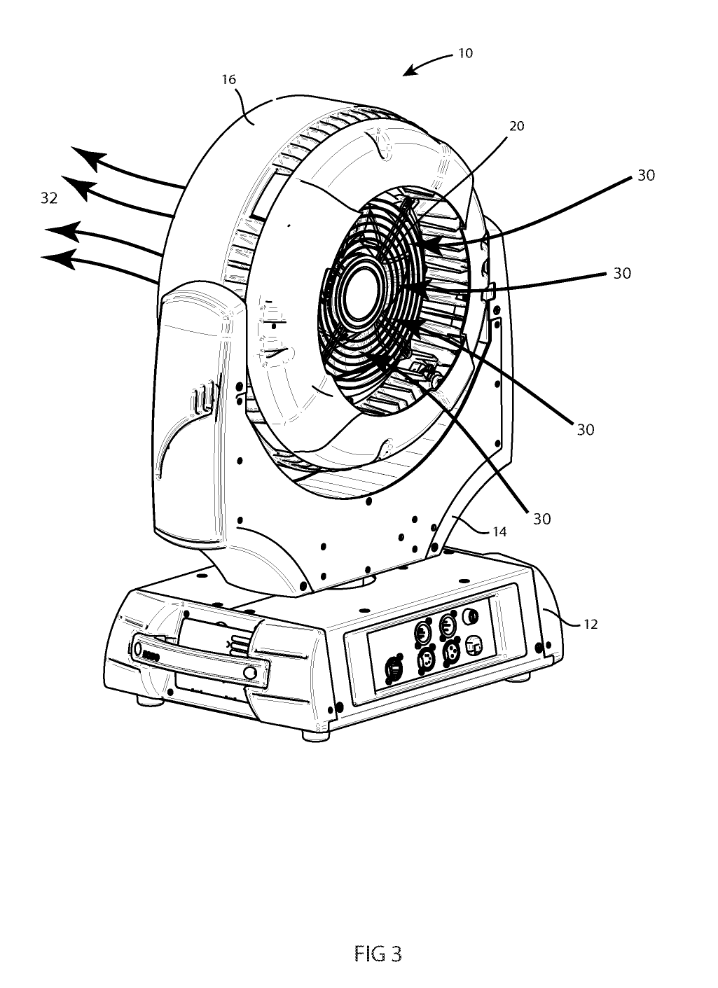

FIG. 3 illustrates the air flow through an embodiment of the invention. Fixture 10 is being viewed from the rear showing the intake side of fan 20. Air from the surrounding area 30 enters the inlet of fan 20 and is constrained into an output jet 32.

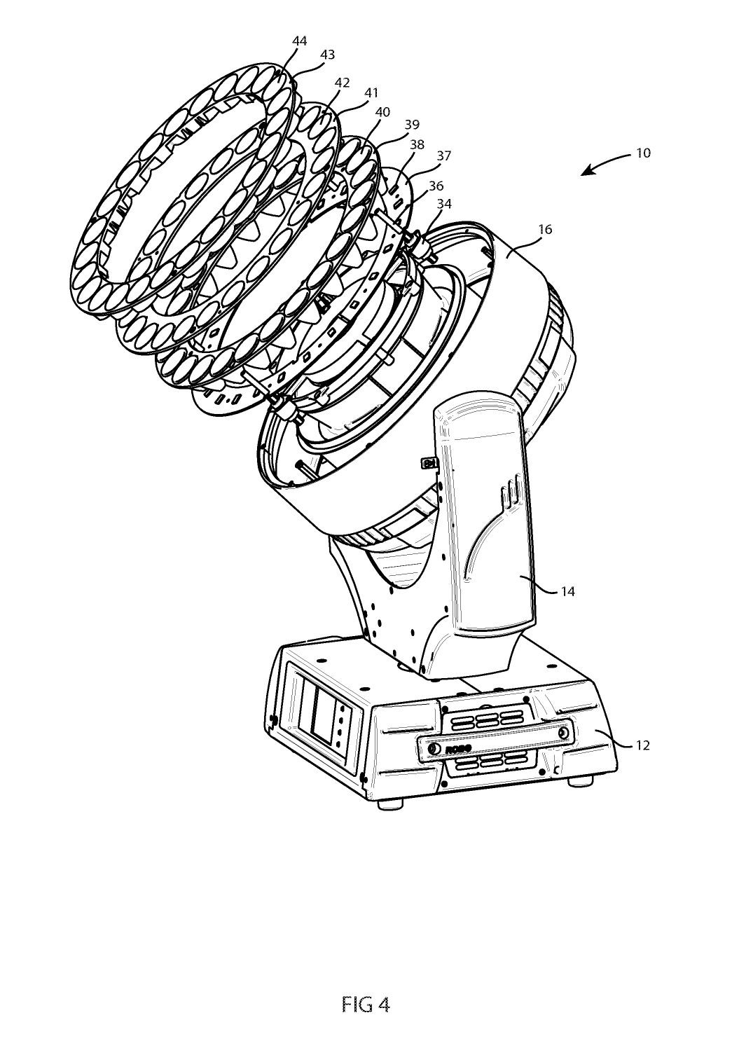

FIG. 4 illustrates an exploded view of an embodiment of the invention, in particular of the LED module structure. LED emitter arrays 38 are mounted to a first ring 37. Ring 37 provides both heatsink and electrical connections for LED emitters 38. Each of the LED emitter arrays 38 is paired with a primary optic 40, mounted on second ring 39. Rings 37 and 39 are fixed in position relative to each other. Third ring 41 contains first micro lens arrays 42. Fourth ring 43 contains optical assemblies 44, each of which may contain a second micro lens array and louver masks. Rings 41 and 43 are fixed in position relative to each other and are mounted to output rods 36 which, in turn, are controlled by stepper motor linear actuators 34.

In operation stepper motor linear actuators 34 may be caused to turn by the user and the rotation, through a linear screw mechanism, produces linear motion in output rods 36. This motion allows the combined assembly of third ring 41 and fourth ring 43 to be moved in a direction parallel to the optical axis of LED emitter arrays 38, associated primary optics 40, and first micro lens arrays 42. This motion backwards and forwards provides an optical zoom system which allows control of the final emitted beam angle from LED modules. In one embodiment of the invention this movement alters the emitted beam angle of the LED modules from 8° to 63°.

FIG. 5 illustrates operation of the various optical elements of the fixture as they relate to a single LED module 18 of an embodiment of the invention. The light output from an LED emitter array 106 which may contain multiple LEDs of the same or differing colors enters primary optic 126. Primary optic 126 provides beam collimation and may be a reflector or a lens utilizing total internal refection (TIR). After passing through and being constrained by primary optic 126 the light beam enters first and second micro lens arrays 122 and 123. In the embodiment illustrated the first micro lens array 122 is fixed in position relative to LED emitter array 106 and primary optic 126 while second micro lens array 123 is able to move 121 along or parallel to the optical axis 150 of the system. The two micro lens arrays 122 and 123 together form an optical system whose focal length may be varied by moving second micro lens array 123 towards and away from first micro lens array 122 as indicated by arrow 121. The micro lenses in micro lens arrays 122 and 123 may both face in the same direction as illustrated here or may face in opposing directions. The use of micro lens arrays as opposed to single larger lenses has a number of advantages, including but not limited to:
a. Micro lens arrays may be significantly thinner than a single lens of the same focal length and thus lighter and easier to move.
b. Micro lens arrays may provide homogenization of the light beam as well as altering the beam divergence.

In the present disclosed embodiment second micro lens array 123 is associated with a first, small, louver mask 120 which may be attached to second micro lens 123 and will move along the optical axis with it. Small louver mask 120 may be in contact with second micro lens array 123 in order to maximize the effectiveness and prevent any stray light from passing underneath small louver mask 120. As the combination of second micro lens array 123 and associated small louver mask 120 traverses backwards and forwards along or parallel to the optical axis 150 of the optical system as indicated by arrow 121 the focal length of the optical system formed by micro lens arrays 122 and 123 and primary optic 126 will vary, and thus the divergence of the light beam exiting second micro lens array 123 will vary as it passes through small beam louver 120. This resultant output beam is then further constrained by second, large, beam louver 124.

Large beam louver 124 may be in a fixed position relative to LED emitter array 106, primary optic 126, and first micro lens array 122, or may be allowed to traverse along the optical axis of the optical system in conjunction with small louver mask 120 and micro lens array 123 as illustrated in FIG. 5 and indicated by arrow 121. In either configuration large beam louver 124 provides a further masking of any stray light from the variable focal length system and further serves to eliminate colored fringing from the light beam.

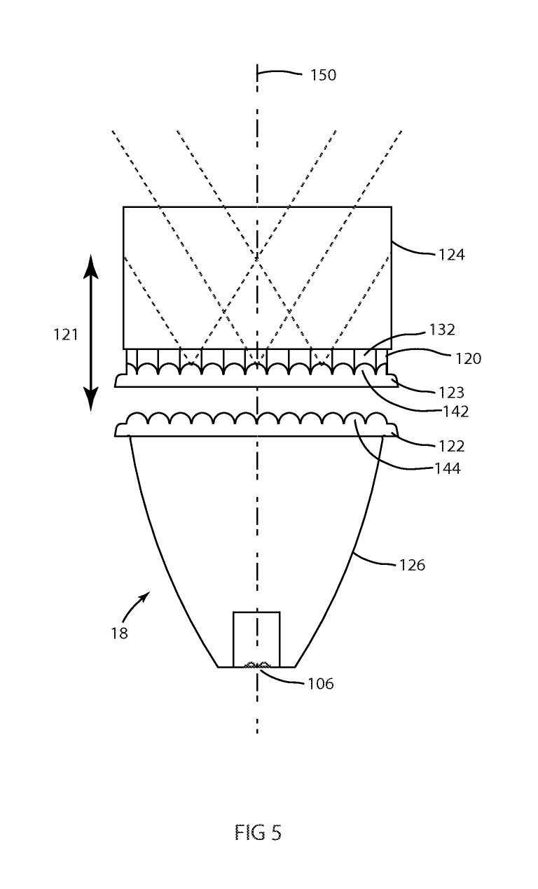

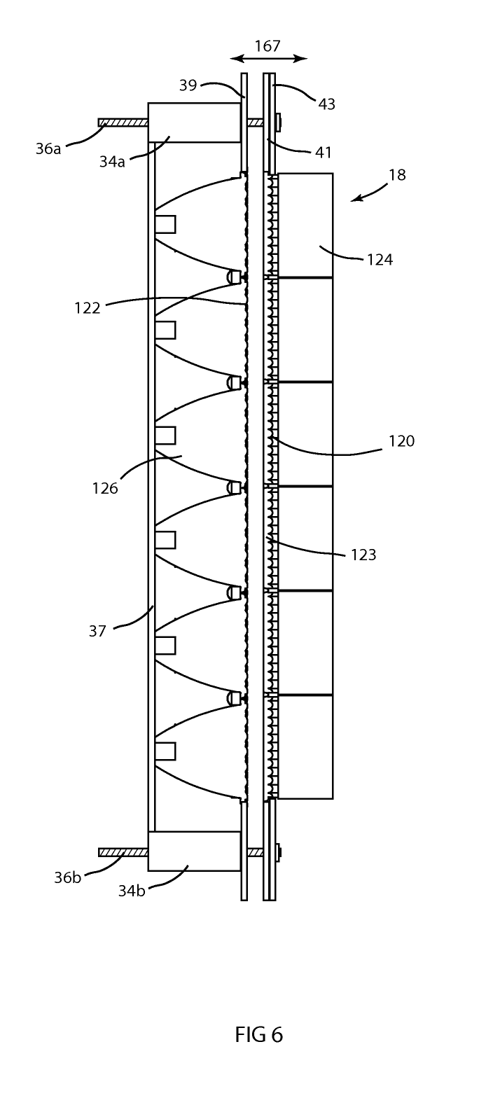

FIG. 6 illustrates a side view of the embodiment detailed in FIG. 5 showing how the movement may be achieved. Louver masks 120 and 124 and second micro lens array 123 are respectively mounted to third ring 41 and fourth ring 43. Stepper motor linear actuators 162 and 163 are mounted to plate 166 which is fixed relative to first micro lens array 122 mounted to second ring 39, and primary optic 126 mounted to first ring 37. The output rods 36a and 36b of stepper motor linear actuators 34a and 34b are connected to third ring 41 and fourth ring 43. As stepper motor linear actuators 34a and 34b are operated their respective output rods 36a and 36b will be extended or retracted, causing third ring 41 and fourth ring 43 and attached louver masks 120 and 124 and second micro lens array 123 to move away from or closer to first micro lens array 122 and primary optic 126. Although two stepper motor linear actuators are herein illustrated the invention is not so limited and any number of stepper motor linear actuators may be utilized. Stepper motor linear actuators 34a and 34b may be operated cooperatively and simultaneously such that third ring 41 and fourth ring 43 and their attached optical assembly remains parallel to first ring 37 and second ring 39 and their attached optical assembly.

In various embodiments Each LED emitter array 106 may comprise a single LED die of a single color or a group of LED dies of the same or differing colors. For example in one embodiment LED 106 comprises one each of a Red, Green, Blue and White die. In some embodiments these LED die(s) may be paired with optical lens element(s) as part of the LED module. Though the LED emitter array 106 shown are illustrated as individual pieces, in various embodiments these emitter array 106 may set out in an array of multiple modules as a one piece or multiple pieces. Similarly the primary optics 126 are illustrated as one piece per LED emitter array. In other embodiments the primary optics may be configured in an array of multiple primary optics to be paired with an array of multiple LED emitter array. Likewise the first micro lens arrays 122 are illustrated as individual pieces. In other embodiments the first micro lens arrays 122 may be part of a larger array to be paired with an array of multiple LED modules.

In one embodiment of the invention every louver mask 120 on each module in the luminaire is identical and every cell within those masks is also identical but in further embodiments the louver masks 120 or cells may differ within a single module or between different modules across the luminaire. In yet further embodiments the height of louver mask array 120 may be varied to effect different controlled beam angles for the emitted light. Such combinations of differing optical elements and louver array height may be advantageously chosen so as to allow fine control of the beam shape and quality. The louver mask arrays reduce color fringing or halation and control the beam angle to provide the lighting designer with a well-controlled and defined beam of a single homogeneous color.

It can be seen that changing the heights of one or both louver masks 120 and 124 will alter the constrained beam angle of the output beam. A taller louver will produce a narrower beam and a shorter louver will produce a wider beam. The louver masks 120 and 124 may be of fixed height or may be adjustable. Louver masks 120 and 124 may be non-reflective so as to avoid spill light, this may be achieved by painting or coating the louver mask with matte black paint, anodizing or other coating as known in the art. LED emitter array 106 may contain LEDs of a single color and type or of multiple colors. The invention is not limited by the number, colors, or types of LEDs used and is applicable with any layout of any number of any type and any color of LEDs or OLEDs.

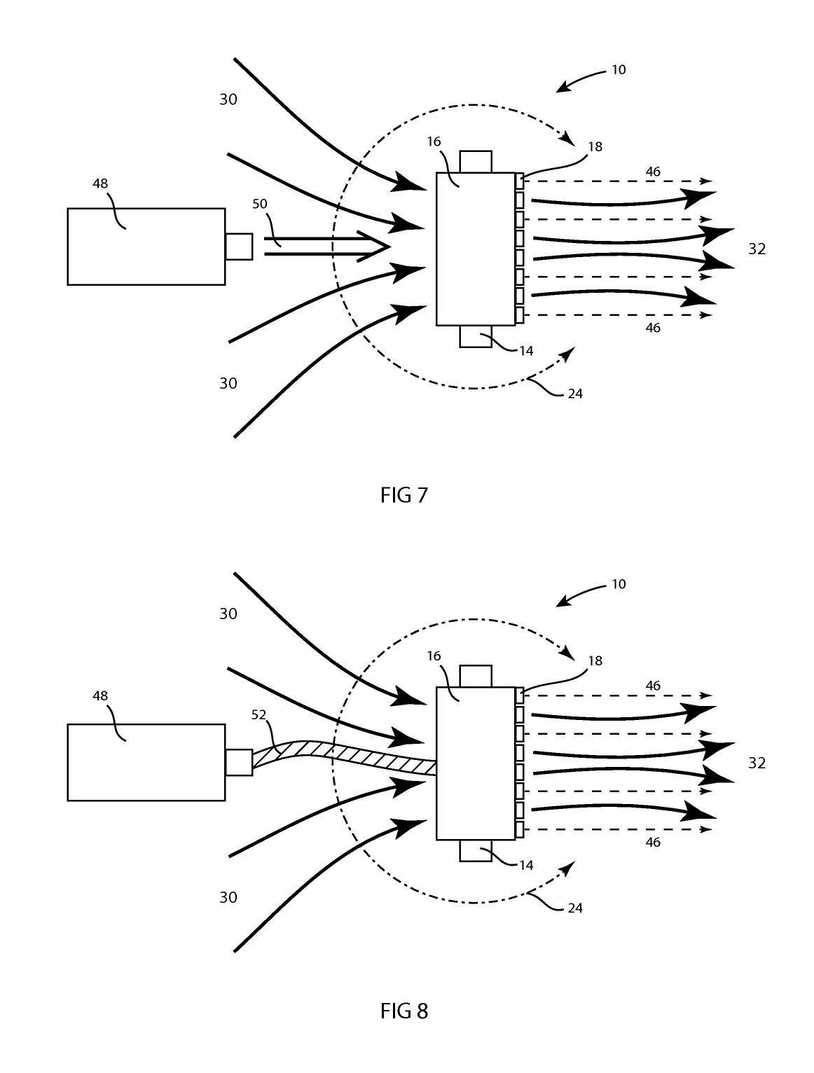

FIG. 7 illustrates an embodiment of the invention operating with a fog machine. “fog” machines or “haze” or “smoke” machines are named after the effects they generate, not necessarily that the produce fog or smoke. Many if not most times, it would be more accurate to use the term “faux fog” or “faux smoke”. For the purposes of this application it is not significant whether the smoke or fog is real of faux the terms are intended to be all inclusive for the intended effect i.e. “fog” means real or faux fog, has smoke or similar effect.

Fog machine 48 may be a standard theatrical fog or haze machine which produces a fine mist of droplets of a working fluid such as a glycol solution. These small droplets produce an artificial fog in the air which provides a surface that may be illuminated. The technique of using light levels of fog or haze in the air is commonly used in theatrical presentations to allow the audience to see lights beams as apparently solid beams of light and is well known in the art. In the illustrated embodiment fog machine 48 directs its output of fog or haze towards the input of the fan within fixture head 16. The fan then directs that fog, along with surrounding air, as output jet 32. Output jet 32, now containing a mixture of fog and air, is illuminated by the light beams 46 emitted from LED modules 18. The appearance to the audience is of a solid beam of light that will move as fixture head 16 is moved in, for example, the pan direction 24. The operator may adjust the fan speed, fog amount, beam angle of the LED modules, color and brightness of the LED modules, and the positioning of head 16 in order to obtain a multitude of effects. In this embodiment fog machine 48 remains stationary.

FIG. 8 illustrates a further embodiment of the invention operating with a fog machine. This embodiment is similar to that shown in FIG. 7, however, in this case fog the fog output of fog machine 48 is directed into the inlet of the fan in fixture head 16 through flexible hose 52. Fog machine 48 may remain stationary, however flexible hose 52 will allow the fog output to follow the movements of fixture head 16 and continue to direct fog into the fan.

In yet further embodiments fog machine 48 may be attached to and move with fixture head 16.

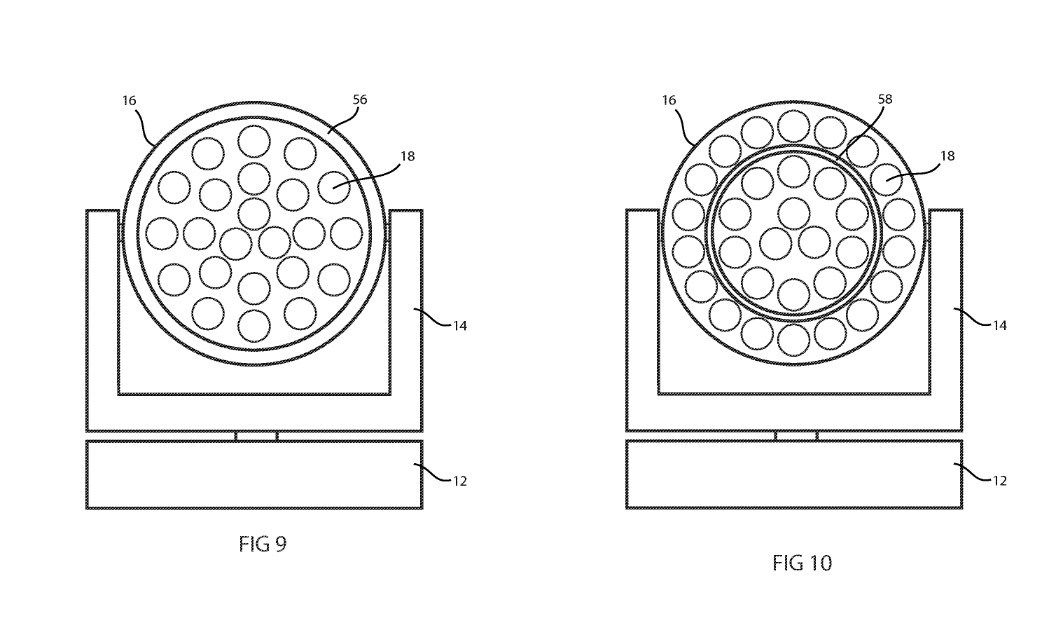

FIG. 9 illustrates a further embodiment where the airflow from the fan (not shown) is channeled through outer air channel 56. FIG. 10 illustrates an alternative embodiment to the embodiment where the airflow generated by the fan is channeled through channel 58 which is interspaced within the array of LED's 18. One of the advantages of the use of the channels 56 and/or 58 is that the buffeting of the air caused by the rotating fan blades is reduced by the air channel. In further embodiments these airchannels are of the type employed by circular fans from Dyson where the fan is remotely located and can be filtered as it passes through the chamber it drags along nearby air in a multiplier effect. In these further embodiments the nearby air is the fog laden air. The advantage of this design is that it avoids the fog condensate on the fan blades which then attracts dirt and dust particles requiring more frequent cleaning of the fan blades which are more difficult to clean than the air channels.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An automated luminaire creating a directable beam of light with an airflow generator which generates an air stream along the light beam.

2. The automated luminaire of claim 2 where the beam of light and the airstream are coaxial.

3. The automated luminaire comprising:
a light engine which creates a directable beam of light;
an air handler for generating an air stream along the light beam.

4. The automated luminaire of claim 3 where the light engine and air handler are co-mounted in the articulated head of a yoke gimbal.

5. The automated luminaire of claim 4 where the beam of light and the airstream are coaxial.

6. The automated luminaire of claim 5 where the air handler has exit port(s) and the light engine surrounds the air handler exit port which occupies a center space.

7. The automated luminaire of claim 2 where the air handler has exit port(s) between light engine exit ports.

8. The automated luminaire of claim 5 where the air handler has exit port(s) which surround the light engine which occupies a center space.

9. The automated luminaire of claim 3 where the air handler has inlet port(s) receiving output from a “fog” machine.

10. The automated luminaire of claim 9 where the air handler inlet port(s) are directly connected to the “fog” machine.

11. The automated luminaire of claim 3 where light engine can vary the beam angle of the light beam it generates.
